(19) United States
(12) Patent Application Publication
(10) Pub. No.: US 2005/0122953 A1
(43) Pub. Date: Jun. 9, 2005

(54) Method and device for one-way or two-way data transmission

(76) Inventor: Gregor Ilic, Darmstadt (DE)

Correspondence Address: RANKIN, HILL, PORTER & CLARK LLP, 4080 ERIE STREET, WILLOUGHBY, OH, 44094-7836, US

(21) Appl. No.: 10/503,298

(22) PCT Filed: Dec. 2, 2002
(86) PCT No.: PCT/DE02/04416

(30) Foreign Application Priority Data
Dec. 4, 2001 (DE) 101 59 290.6
Mar. 5, 2002 (DE) 102 09 501.9

(51) Int. Cl. H04L 12/28

(52) U.S. Cl. 370/351

(57) ABSTRACT

A method for uni/bidirectional data communication between at least two devices, the one device sending the data—first device—and the other device receiving the data—second device—and both devices being connected by means of a communication module. For convenient, universal application the communication module recognizes at least one of the devices and/or permits compatible data exchange of the devices. Also cited is a corresponding apparatus for uni/bidirectional data communication.

The invention relates to a method and an apparatus for uni/bidirectional data communication between at least two devices, the one device sending the data—first device—and the other device receiving the data—second device—and both devices being connected by means of a communication module.

Methods and apparatuses for uni/bidirectional data communication between at least two devices have been known for a long time in prior art. For example, DE 295 18 675 U1 discloses a method and an apparatus for unidirectional data communication between two devices, one of which is a bar code scanner and the other is a mobile telephone. The communication module is devised as an attachment into which the bar code scanner is inserted for communicating the data and which is wired via a connector to a mobile telephone. In this arrangement, by means of the bar code scanner data is read from the bar code and once the bar code scanner has been inserted into the communication module the data is communicated to the mobile telephone via a connector connecting the mobile telephone.

The drawback in this known method and apparatus is that the communication module is dedicated to two defined devices only. Thus, it is not possible, for example, to operate the communication module with any other device than this particular bar code scanner and particular mobile telephone as defined by the connection. This is because, for one thing, the communication module is designed exclusively for the format of particular data concerned or for transfer of the data format of the devices involved, and for another, the defined design thereof makes it incompatible with other devices. Accordingly, other fields of application and tasks make it necessary to use some other communication module. This, however, is a nuisance in requiring various other communication modules to be carried along and expensive due to a separate communication module being needed for each task.

The object of the present invention is thus based on defining a method and apparatus for uni/bidirectional data communication of the aforementioned kind which now permit convenient and universal application.

In accordance with the invention this object as regards a method for uni/bidirectional data communication is achieved by a method having the features as set forth in claim 1. As it reads from this claim a method for uni/bidirectional data communication of the aforementioned kind is configured such that the communication module recognizes at least one of the devices and/or permits compatible data exchange of the devices.

In addition the above object as regards an apparatus for uni/bidirectional data communication is achieved by an apparatus having the features as set forth in claim 15. As it reads from this claim an apparatus for uni/bidirectional data communication of the aforementioned kind is configured such that the communication module recognizes at least one of the devices and/or permits compatible data exchange of the devices.

The gist of the invention involves having discovered that for convenient and universal application of a method and apparatus for data communication, a communication module is needed which is compatible with a plurality of devices. This is achieved in accordance with the invention in that the communication module is now able to recognize the devices and then modify the data such that the devices are compatible to swap data. This now makes it possible to intercouple a wide variety of devices without having to use a different communication module every time.

In one particularly simple aspect the communication module for recognizing the device could read out the device and/or transmit at least one instruction, particularly an attention command. By means of the attention command the device alerted could then transmit a return signal to the communication module so that the communication module recognizes the device from its response to the attention command. Then, the communication module could adapt the data format to the type of device involved in each case for no-problem communication between the communication module and the individual devices and thus also between the devices themselves. It would also be possible that the communication module transmits a plurality of different instructions, character strings, signals or the like for recognizing the device so that the device responds only to individual instructions, character strings, signals. In other words, the communication module would thus establish by trial and error the correct instruction, correct character string or correct signal to permit recognizing the device.

The recognized device could then be initialized by means of the communication module. Initializing could involve an entry window automatically being generated, for example, a short message service (SMS) message when the device is, for instance, a mobile telephone and that the transferred data is integrated in the entry window or SMS message. In this arrangement, initializing could even involve supplementing the data for example by a telephone number to which the message is to be sent so that supplementing the data is only needed when required, as would be particular user-friendly. Analogously, initializing could also be performed by a computer, more particularly by a laptop or a personal digital assistant (PDA) as regards an e-mail.

The first device could capture and/or store and/or retrieve data. This data could be, for example, in the form of a bar code, preferably in EAN format, but also in any other machine-readable format, in thus again making for a particularly universal application. The first device could then send the data to the communication module in also being possible, for example, for the communication module to recognize the type of the device involved by way of the data format.

In another aspect for particularly facilitated handling the communication module could supplement the data particular by an internet protocol (IP) address and/or a telephone number and/or an e-mail address or the like, although of course any other data could be supplemented. In yet another advantageous aspect the data could be linked with further data from a data base. Supplementing and/or linking the data could be done in real time to make for a particularly convenient aspect. The data could, additionally or alternatively, also be supplemented by a dedicated ID number preferably stored in the communication module. This ID number would enable the data to be dedicated to a special user and/or special devices thus permitting, for example, invoicing of services.

The communication module could then convert the data into data readable by the second device, and/or store and/or send the data to the second device, it also being possible, for example, that initializing the second device is linked to sending the data.

In a particularly user-friendly aspect the second device could communicate the data, for example via SMS, cia wireless application protocol (WAP), e-mail or the like to a means such as, for example, a data processing means such as a server-client-system, an IP address or the like. In this arrangement, the nature of the data communication could be stored in the communication module. Thereby, the nature of the data communication could be a function of the device recognized in each case. Thus, it could be stored in the communication module, which transfer medium is to be selected in accordance with the second device. Accordingly, it would be feasible, for example, that the communication module recognizes whether a mobile telephone permits WAP communication. If so, the transfer medium would then be WAP. Should the mobile telephone not support WAP then an SMS would be selected as the transfer medium so that an optimum transfer medium is selected for each second device.

The connection could be made via mobile telephone and/or PDA and/or modem or the like. Data transfer could then be made by WAP and/or hyper text transfer protocol (HTTP) and/or hyper text transfer protocol secure (HTTPS) and/or simple mail transfer protocol (SMTP) and/or file transfer protocol (FTP) or the like, although, of course, any other protocol, for example, post office protocol (POP) and internet message access protocol (IMAP) could be used for data transfer.

The data could then be analyzed and/or supplemented by other information. This would be possible, for example, by the data being communicated by the module to a client, analysis then being done by the client. The data and/or the information could then be communicated by the module in turn to the second device preferably by means of the same transfer medium so that the data and/or the information is available to a user quasi automatically and with minimum delay. The data and/or the information could involve for example products and/or product types and/or price information or the like.

The apparatus in accordance with the invention for uni/bidirectional data communication could serve particularly for application of the method in accordance with the aspects as described above. Preferably this apparatus permits connecting the various devices to one and the same communication module.

In one particularly flexible aspect the first device could be a camera and/or an MP3 player and/or a scanner, more particularly a bar code scanner and/or a GPS system and/or a car radio and/or a portable measurement system and/or card reader system; indeed, any kind of device could be used with which data can be captured and/or stored and/or retrieved, for example, also a device for reading out transponders. Complementary thereto the second device could be a PDA and/or a computer, particularly a laptop and/or a mobile telephone, although any other device suitable for data transfer could be used.

In the scope of particularly flexible applications the communication module may be devised as a module independent of the devices. Alternatively, the communication module could also be embedded in a cable or a device. This would be of advantage since no attachment module would then need to be carried along which is often bulky and which could easily get lost in transit.

In another particularly simple aspect the communication module could be wired to the devices, whereby the wiring system can be swapped at the communication module for compatibility with the device used in each case. When the communication module is connected to a computer, particular to a laptop this could be done by means of a PCMCIA card. Also, it would be just as possible to connect the communication module by means of a universal serial bus (USB) or by means of USB technology to the devices. Additionally or alternatively the communication module could connect the devices also by a wireless and/or infrared link or the like. Any other wireless form of connection would also be feasible.

To make for a particular high degree of user-friendly operation the communication module could comprise display and/or control elements in the form of a display and/or light emitting diodes (LEDs) as well as a keypad, switches or other control elements. Also feasible is a touch screen for user interaction. By means of the control elements a user could select, for example, a special service or a special protocol, a telephone number or a particular end device so that the communication module also permits connecting two devices not automatically recognized or in taking into account personal preferences of the user. In this arrangement the configuration of the communication module could be done to particular advantage by means of a special software that may particularly be stored in the communication module.

In addition or alternatively the communication module could comprise output and/or input elements for acoustical signals, more particularly loudspeakers and/or microphones in thus making it possible to alert the user by an acoustical signal to errors for example in data communication. Also possible would be to enter acoustical instructions into the communication module by means of voice recognition.

In yet another particularly user-friendly aspect the communication module could comprise in addition sensorial elements, particular vibration elements. This would again make for interaction with a user, for instance, by the sensorial elements keeping him informed as to special status events of the communication module.

In the scope of a particular simple means of power supply the communication module could be powered by means of one of the devices. As an alternative or in addition thereto the communication module could, however, also be powered by a separate power supply, for example by means of an internal or external power supply and/or a rechargeable battery or the like. However, any other form of power supply is just as feasible, thus, for example, solar, goldcap, fuel cell or the like.

There are many aspects to the teaching of the present invention, reference being made in this respect, on the one hand, to the sub-claims of claims 1 and 15, and, on the other, to the example embodiment of the method in accordance with the invention and the apparatus in accordance with the invention as detailed in the following, in conjunction with which also the preferred aspects and further embodiments of the teaching are explained.

In the example embodiment the first device is a bar code scanner and the second device is a mobile telephone. The communication module is independent of the devices wiring the bar code scanner to the mobile telephone.

Connecting the module to the bar code scanner and to the mobile telephone causes the module to send an attention command (AT-command) to the mobile telephone and a corresponding instruction to the bar code scanner. The types of the devices involved are recognized from the response and the module institutes suitable data transfer between the devices.

By means of the bar code scanner, data—namely a product type—is sensed from a bar code applied to a product. The bar code scanner sends the data to the module which supplements the data with an ID number. This supplemented data is converted by means of the module into a format compatible with the mobile telephone and communicated to the mobile telephone. Communicating the data to the mobile telephone initializes the mobile telephone in generating an SMS containing the product type as well as the ID number and addressed to an internet vendor.

After the user has confirmed the data, the SMS is sent to the internet vendor. The internet vendor establishes from the data, namely from the product type the best price for this particular product from a data base. By means of the ID number the action is assigned to the account of the user and stored for later invoicing. The internet vendor then communicates the price information via SMS back to the mobile telephone of the user. The user can then decide to purchase or not from the available information.

To avoid tedious repetition, reference is made to the general discussion in the description as well as to the attached claims as regards further advantageous aspects of the teaching in accordance with the invention.

In conclusion, it is to be noted expressly that the example embodiment as described above merely serves in explaining the claimed teaching which is in no way restricted to this particular example embodiment.

1. A method for uni/bidirectional data communication between at least two devices, the one device sending the data—first device—and the other device receiving the data—second device—and both devices being connected by means of a communication module, wherein the communication module recognizes at least one of the devices and/or permits compatible data exchange of the devices.

2. The method as set forth in claim 1, wherein the communication module for recognizing the device reads out the device and/or transmits at least one instruction, particularly an attention command.

3. The method as set forth in claim 2, wherein the communication module recognizes the device from its response to the instruction.

4. The method as set forth in claim 3, wherein the recognized device is initialized by means of the communication module.

5. The method as set forth in claim 1, wherein the first device captures and/or stores and/or retrieves data.

6. The method as set forth in claim 5, wherein the first device sends the data to the communication module.

7. The method as set forth in claim 1, wherein the communication module supplements the data particularly by an IP address and/or a telephone number and/or an e-mail address or the like.

8. The method as set forth in claim 1, wherein the communication module converts the data into data readable by the second device, and/or stores and/or sends the data to the second device.

9. The method as set forth in claim 8, wherein the second device communicates the data, for example via SMS, via WAP, e-mail or the like to a means such as, for example, a server, an IP address or the like.

10. The method as set forth in claim 8, wherein a nature of the data transfer is stored in the communication module.

11. The method as set forth in claim 9, wherein connection is made via mobile telephone and/or PDA and/or modem or the like.

12. The method as set forth in claim 11, wherein data communication is made by WAP and/or HTTP and/or HTTPS and/or SMTP and/or FTP or the like.

13. The method as set forth in claim 9, wherein the data is analyzed and/or supplemented by information.

14. The method as set forth in claim 1, wherein the data and/or the information comprises products and product types and/or price information or the like.

15. An apparatus for uni/bidirectional data communication between at least two devices, the one device sending the data—first device—and the other device receiving the data—second device—and both devices being connected by means of a communication module, particularly for application of the method as set forth in claim 1, wherein the communication module recognizes at least one of the devices and/or permits compatible data exchange of the devices.

16. The apparatus as set forth in claim 15, wherein the first device is a camera and/or an MP3 player and/or a scanner, more particularly a bar code scanner and/or a GPS system and/or a car radio and/or a portable sensing system and/or card reader system.

17. The apparatus as set forth in claim 15 wherein the second device is a PDA and/or a computer, particularly a laptop and/or a mobile telephone.

18. The apparatus as set forth in claim 15, wherein the communication module is devised as being independent of the devices.

19. The apparatus as set forth in claim 15, wherein the communication module is embedded in a cable.

20. The apparatus as set forth in claim 15, wherein the communication module is embedded in one of the devices.

21. The apparatus as set forth in claim 15, wherein the communication module connects the devices by wiring.

22. The apparatus as set forth in claim 15, wherein the communication module connects the devices by a wireless and/or infrared link or the like.

23. The apparatus as set forth in claim 15, wherein the communication module comprises display and/or control elements.

24. The apparatus as set forth in claim 15, wherein the communication module comprises output and/or input elements for acoustical signals, particularly loudspeakers and/or microphones.

25. The apparatus as set forth in claim 15, wherein the communication module comprises sensorial elements, particular vibration elements.

26. The apparatus as set forth in claim 15, wherein the communication module is powered by means of one of the devices.

27. The apparatus as set forth in claim 15, wherein the communication module is powered by means of an external energy supply, for example, by means of an internal or external power supply and/or a rechargeable battery or the like.
